(19) United States
(12) Patent Application Publication
(10) Pub. No.: US 2025/0135670 A1
(43) Pub. Date: May 1, 2025

(54) SURFACE-TREATED CUTTING BLADES DEMONSTRATING EXTENDED BLADE EDGE RETENTION AND DECREASED FRICTION, AND METHODS OF REDUCING DEPOSITION OF A CONTAMINANT ON A SURFACE OF A METAL CUTTING BLADE

(71) Applicant: ACULON, INC., SAN DIEGO, CA (US)

(72) Inventors: Eric L. Hanson, Carlsbad, CA (US); Eric L. Bruner, La Jolla, CA (US); Majid Monji, San Diego, CA (US); Justin Hardin, Poway, CA (US); Edward Hughes, San Diego, CA (US); Qian He, San Diego, CA (US); Gloria Zarate, Oceanside, CA (US)

(21) Appl. No.: 18/958,690

(22) Filed: Nov. 25, 2024

Related U.S. Application Data
(63) Continuation of application No. PCT/US23/11925, filed on Jan. 31, 2023.
(60) Provisional application No. 63/345,615, filed on May 25, 2022.
(60) Provisional application No. 63/432,215, filed on Dec. 13, 2022.

(51) Int. Cl. B26B 21/60; C23C 22/05

(52) U.S. Cl. CPC B26B 21/60; C23C 22/05

(57) ABSTRACT

Surface-treated cutting blades are provided, comprising: (a) a metal cutting blade body; and (b) a self-assembled monolayer formed from an alkoxysilane and/or organophosphonic acid. The surface-treated cutting blades may further comprise one or more layers formed from chrome, tantalum, titanium, an aqueous solution of a metal salt, and/or an organometallic compound, applied between the cutting blade and the self-assembled monolayer. Also provided is a method of reducing deposition of a contaminant on a surface of metal cutting blade, comprising: (a) contacting the surface either directly or through an intermediate organometallic layer with a fluorinated material in a diluent; (b) forming a film on the surface; and (c) exposing the cutting blade to the contaminant.

### RELATED APPLICATIONS

The present application is a continuation of International Patent Application PCT/US2023/011925 filed Jan. 31, 2023 and published as WO 2023/229673 which application and publication are incorporated herein by reference.

International Patent Application PCT/US2023/011925 claims priority to U.S. Provisional Patent Application No. 63/345,615 filed May 25, 2022 and to U.S. Provisional Patent Application No. 63/432,215 filed Dec. 13, 2022, which applications are incorporated herein by reference.

### FIELD OF THE INVENTION

The present invention relates to surface-treated cutting blades comprising self-assembled monolayers, and methods of reducing deposition of a contaminant on a surface of a metal cutting blade.

### BACKGROUND OF THE INVENTION

Cutting blades are commonly used in industrial, medical, and residential settings and include scalpels, paper cutters, scissors, utility knives, kitchen cutlery, razor blades and the like.

Often the blade surfaces are treated to increase the edge life (thus reducing needs for sharpening and/or replacement). Blades may also be treated to decrease the friction of the surface for ease and efficiency of use, and in the case of razor blades, for example, for the safety and comfort of the user.

Surface treatments for decreasing friction have included perfluoroalkyl and polyfluoroalkyl substances (PFAS), a group of man-made chemicals that include Perfluorooctane Sulfonate (PFOS) and Perfluorooctanoic Acid (PFOA). However, increasing numbers of restrictions on the use of perfluorinated substances in view of suspected health risks have driven the need for change in many industries, including cutting blades. Restrictions on amounts of allowed PFOA and PFOS has eliminated the use of some surface coating products and driven the need for new alternatives. One area of interest is in cutting blades including razor blades.

U.S. Patent Publication 2012-0034470 discloses surgical devices, needles such as surgical needles, razors, cutting/slicing devices containing a metallic surface, a primer layer disposed on the metallic surface, and a top coat disposed on the primer layer, wherein the primer layer is formed from a primer composition containing a silanol-containing organopolysiloxane resin and a crosslinking agent selected from the group consisting of alkyl silicates, boric acid, borates, acetoxysilanes, ketoximesilanes, and combinations thereof, and wherein the top coat is formed from a top coat composition containing an alkenyl functional polyorganosiloxane, an organohydrogensiloxane, and a hydrosilylation catalyst.

U.S. Pat. No. 5,700,523 discloses a method for treating a metal surface by contacting the metal surface with an aqueous silicate solution, contacting the silicate-coated metal surface with an aqueous organo-functional silane solution, and then contacting the silane-coated metal surface with a chrome-free pretreatment.

Applicant's prior U.S. Pat. No. 7,740,940 discloses a coated article comprising a substrate having a plastic surface and adhered thereto an organometallic film in which the metal has f electron orbitals or is niobium is disclosed. Also disclosed are methods for applying organometallic films to substrates and the organometallic films themselves.

U.S. Patent Publication 2018-0015203 discloses self-assembled organosilane coatings for resorbable medical implant devices. The coatings can be prepared from coating compositions containing organosilane and can be applied to metal or metal alloy substrates. The coatings can be functionalized with a binding compound that is coupled with an active component. The coatings can be applied using various techniques and apparatus, more particularly, by a deep-coating process conducted at ambient conditions.

It would be desirable to provide novel, surface-treated cutting blades that may be produced using safe components without the drawbacks of the prior art.

### SUMMARY OF THE INVENTION

The present invention is directed to surface-treated cutting blades comprising:
(a) a metal cutting blade body;
(b) a first layer applied to at least one surface of the metal cutting blade body, wherein the first layer is formed from:
   (i) an aqueous solution of a metal salt; or
   (ii) an organometallic compound; and
(c) a self-assembled monolayer (SAM) applied to at least a portion of the first layer, wherein the self-assembled monolayer is formed from an alkoxysilane.

The present invention is further directed to a surface-treated cutting blade comprising:
(a) a metal cutting blade body;
(b) a first layer applied to at least one surface of the cutting blade body, wherein the first coating layer comprises chrome, tantalum or titanium having a thickness of 2 nm to 200 nm;
(c) an intervening layer applied to at least a portion of the first layer, wherein the intervening layer is formed from an aqueous solution of a metal salt; and
(d) a self-assembled monolayer applied to at least a portion of the first layer, wherein the self-assembled monolayer is formed from a monophosphonic acid.

The present invention is further directed to a surface-treated cutting blade comprising:
(a) a metal cutting blade body; and
(b) a self-assembled monolayer applied directly to at least a portion of the metal cutting blade body (a), wherein the self-assembled monolayer (b) is formed from a non-fluorinated organophosphonic acid and/or an alkoxysilane.

The present invention is also directed to methods of reducing deposition of a contaminant on a surface of metal cutting blade, the methods comprising:
(a) contacting the surface either directly or through an intermediate organometallic layer with a fluorinated material in a diluent, wherein the fluorinated material has the following structure:

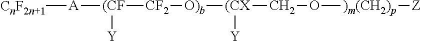

wherein A is an oxygen radical or a chemical bond; n is 1 to 20; Y is H, F, CₙH₂ₙ₊₁ or CₙF₂ₙ₊₁; X is H or F; b is at least 1, m is 0 to 50, p is 1 to 20, and Z is an acid group or an acid derivative;
(b) forming a hydrophobic surface layer on the surface; and
(c) exposing the cutting blade to the contaminant.

These and other advantages of the present invention will be clarified in the following description of the present invention taken together with the attached figures in which like reference numerals represent like elements throughout.

### BRIEF DESCRIPTION OF THE DRAWINGS

FIG. 1 is a schematic cross-sectional view of a surface-treated cutting blade of the present invention.

FIG. 2 is a schematic cross-sectional view of a surface-treated cutting blade of the present invention.

FIG. 3 is a schematic cross-sectional view of a surface-treated cutting blade of the present invention.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used in the following description and claims, the following terms have the meanings indicated below:

By “polymer” is meant a polymer including homopolymers and copolymers, and oligomers. By “composite material” is meant a combination of two or more differing materials.

As used herein, “formed from” denotes open, e. g., “comprising,” claim language. As such, it is intended that a composition “formed from” a list of recited components be a composition comprising at least these recited components, and can further comprise other, non-recited components, during the composition's formation.

As used herein, the term “inorganic material” means any material that is not an organic material.

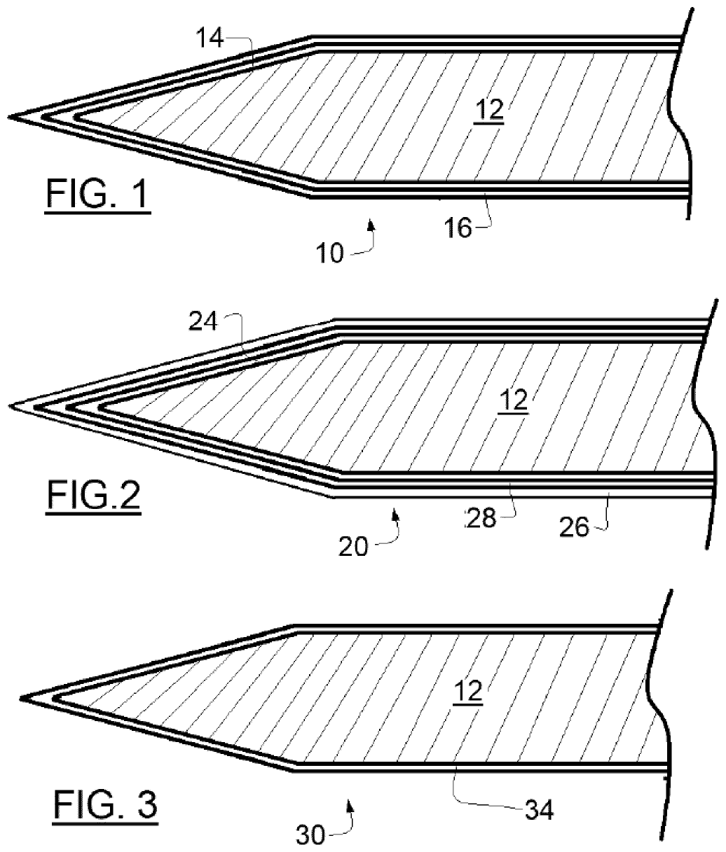

As noted above, the present invention is directed to surface-treated cutting blades 10 as shown, for example, in FIG. 1. The cutting blades 10 comprise a metal cutting blade body 12 (or simply blade 12), typically in the form of a sheet having opposing surfaces, and the blade body 12 may comprise a metal commonly used in the art such as ferrous metals, non-ferrous metals and combinations thereof. Suitable ferrous metals include iron, steel, and alloys thereof. Non-limiting examples of useful steel materials for the blade body 12 include carbon steel, tool steel, and stainless steel. Also, aluminum, aluminum alloys, zinc-aluminum alloys, aluminum plated steel and aluminum alloy plated steel substrates may be used, as well as magnesium metal, titanium metal, chromium metal (chrome), and alloys thereof. Combinations of metals such as steel coated with chrome are also suitable for the blade body 12. The cutting blade 10 may be rigid or flexible, depending on the composition and thickness of the blade body 12. Depending on the intended use, the cutting blade body 12 has at least one tapered (sharpened) edge. The tapered edge of the blade body 12 may have one bevel or multiple bevels of different pitch on one surface of the blade 10, or may have bevels on both opposing sides of the blade 10, as shown in the figures. The bevels may be flat or concave. Often the metal cutting blade 10 comprises a razor blade, although other cutting blades such as scalpels, paper cutters, scissors, utility knives, kitchen cutlery, and the like are suitable.

In certain examples of the present invention, the metal cutting blade 10 may be made of steel, such as stainless steel or other steel alloys, and/or titanium. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C.

In certain examples of the present invention as shown in FIG. 1, the surface-treated cutting blades 10 further comprise (b) a first layer 14 applied to at least one surface of the metal cutting blade body 12. Often, the first layer is applied to the entire blade surface of the blade body 12, such as both opposing surfaces, particularly when the coating layer is applied by immersion. Note that a chrome, tantalum, or titanium layer similar to that described below may be applied to at least one surface of the metal cutting blade body 12 prior to application of the first layer 14.

The first layer 14 may be formed from (i) an aqueous solution of a metal (such as an alkali or alkaline earth metal) salt. The aqueous solution of metal salt may partially form an oxide when deposited. Examples of suitable metals salts include, inter alia, sodium silicate.

The first layer 14 may alternatively be formed from (ii) an organometallic compound. The organometallic compound is usually derived from a metal or metalloid, often a transition metal, selected from Group Ill and Groups IIIB, IVB, VB and VIB of the Periodic Table. Transition metals are used most often, such as those selected from Groups IIIB, IVB, VB and VIB of the Periodic Table. Examples are tantalum, titanium, zirconium, lanthanum, hafnium and tungsten. Niobium is also a suitable metal. The organo portion of the organometallic compound is selected from those groups that are reactive with the organophosphorus acid. Also, as will be described later, the organo group of the organometallic compound is believed to be reactive with groups on the surfaces being treated such as oxide and hydroxyl groups. Examples of suitable organo groups of the organometallic compound are alkoxide groups containing from 1 to 18, usually 2 to 4 carbon atoms, such as ethoxide, propoxide, isopropoxide, butoxide, isobutoxide, tert-butoxide and ethylhexyloxide. Mixed groups such as alkoxide, acetyl acetonate and chloride groups can be used.

The organometallic compounds can be in the form of simple alkoxylates or polymeric forms of the alkoxylate, and various chelates and complexes. For example, in the case of titanium and zirconium, the organometallic compound can include one or more of:
a) alkoxylates of titanium and zirconium having the general formula M(OR)4, wherein M is selected from Ti and Zr and R is C1-18 alkyl,
b) polymeric alkyl titanates and zirconates obtainable by condensation of the alkoxylates of (a), i.e., partially hydrolyzed alkoxylates of the general formula RO[-M(OR)₂O—]x-1R, wherein M and R are as above and x is a positive integer,
c) titanium chelates, derived from ortho titanic acid and polyfunctional alcohols containing one or more additional hydroxyl, halo, keto, carboxyl or amino groups capable of donating electrons to titanium. Examples of these chelates are those having the general formula:

Ti(O)a(OH)b(OR′)c(XY)d
wherein a=4-b-c-d; b=4-a-c-d; c=4-a-b-d; d=4-a-b-c; R′ is H, C1-18 alkyl, or X-Y, wherein X is an electron donating group such as oxygen or nitrogen and Y is an aliphatic radical having a two- or three-carbon atom chain such as
   I. —CH₂CH₂—, e.g., of ethanolamine, diethanolamine and triethanolamine;
   II.

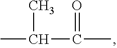

e.g., of lactic acid;
III.

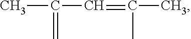

e.g., of acetylacetone enol form; or
IV.

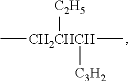

e.g., as in 1,3-octyleneglycol;
d) titanium acrylates having the general formula Ti(OCOR)4-n(OR)n wherein R is C1-18 alkyl as above and n is an integer of from 1 to 3, and polymeric forms thereof, or
e) mixtures thereof.

The organometallic compound can be dissolved or dispersed in a diluent to form a solution. Examples of suitable diluents are alcohols such as methanol, ethanol and propanol, aliphatic hydrocarbons, such as hexane, isooctane and decane, ethers, for example, tetrahydrofuran and dialkyl ethers such as diethyl ether. The concentration of the organometallic compound in the solution is not particularly critical but is usually at least 0.01 millimolar, typically from 0.01 to 100 millimolar, and more typically from 0.1 to 50 millimolar.

Also, adjuvant materials may be present in the solution. Examples include stabilizers such as sterically hindered alcohols, surfactants and anti-static agents. The adjuvants if present are present in amounts of up to 30 percent by weight, based on the non-volatile content of the composition.

The organometallic treatment solution can be prepared by mixing all of the components at the same time or by combining the ingredients in several steps. If the organometallic compound chosen is reactive with moisture, (e. g. in the case of titanium (IV) n-butoxide, tantalum (V) ethoxide, aluminum (III) isopropoxide, etc.), care should be taken that moisture is not introduced with the diluent or adjuvant materials and that mixing is conducted in a substantially anhydrous atmosphere.

The solution (either metal salt or organometallic compound) used to form the first layer 14 can be contacted with the metal cutting blade body 12 typically by immersion, spraying, flow coating, brush application or the like, followed by removing excess solution and evaporating the diluent. This can be accomplished by heating to 50-200° C. or by simple exposure to ambient temperature, that is, from 20-25° C. Alternatively, when using the organometallic compound (ii), the organometallic compound can be used neat and applied by vapor deposition techniques.

When an organometallic compound is used to form the first layer 14, the resulting film may be in the form of a polymeric metal oxide with unreacted alkoxide and hydroxyl groups. This is accomplished by depositing the film under conditions resulting in hydrolysis and self-condensation of the alkoxide. These reactions result in a polymeric metal oxide coating being formed. The conditions necessary for these reactions to occur is to deposit the film in the presence of water, such as a moisture-containing atmosphere; however, these reactions can be performed in solution by the careful addition of water. The resulting film has some unreacted alkoxide groups and/or hydroxyl groups for subsequent reaction and possible covalent bonding with reactive groups in the subsequently applied layer.

Although not intending to be bound by any theory, it is believed the polymeric metal oxide is of the structure:

[M(O)x(OH)y(OR)z]n
where M is the metal being used, R is an alkyl group containing from 1 to 30 carbon atoms; x+y+z=V, the valence of M; x is at least 1, y is at least 1, z is at least 1; x=V-y-z; y=V-x-z; z=V-x-y; n is greater than 2, such as 2 to 1000.

When the organometallic compound is used neat and applied by chemical vapor deposition techniques in the absence of moisture, a thin metal alkoxide film is believed to form. Polymerization, if any occurs, is minimized and the film may be in monolayer configuration.

The resulting first layer 14 typically has a thickness of 0.5 to 100 nanometers. When the organometallic compound is subjected to hydrolysis and self-condensation conditions as mentioned above, somewhat thicker films are formed.

The first layer 14 primarily serves as an adhesion layer, or tie layer, between the metal blade body 12 surface being coated and the self-assembled monolayer 16. It is believed that the use of this first layer 14 also provides extended blade edge retention for blade 10, allowing the blade 10 to remain sharp longer, compared to a similar blade that does not have the first layer applied.

The surface treated cutting blades 10 as shown in FIG. 1 further comprise (c) a self-assembled monolayer 16 applied to at least a portion of the first layer 14. The self-assembled monolayer 16 is formed from an alkoxysilane. The alkoxysilane may comprise a monosilanol, a disilanol, a trisilanol, or mixtures thereof. Additionally or alternatively, the alkoxysilane may comprise functional groups selected from perfluoroalkyl, perfluoroalkyl ether, long-chain hydrocarbons (such as containing at least eight —CH2- groups), polyethylene oxide containing at least three —CH2CH2O— groups, polydialkylsiloxane, and combinations thereof. For example, the alkoxysilane may comprise polydimethylsiloxane. Additionally or alternatively, the alkoxysilane may comprise a polydialkylsiloxane having perfluoroalkyl and/or perfluoroalkyl ether groups. The long chain hydrocarbons and polyethylene oxide may include functional end groups (omega groups) such as hydrophobic groups, including methyl, methoxy, trifluoromethyl, methylene, phenyl, and pentafluorophenyl groups. Another example of a polymeric alkoxysilane is trimethoxysilyl-terminated polyperfluorosilane.

Each of the layers 14 and 16 may be applied by the methods listed above. When using an organometallic compound to form the first layer 14, after application of all layers to the surface of the metal cutting blade body 12 to form a coated substrate, the coated substrate may be subjected to a temperature of 25 to 90° C., typically 60 to 85° C., for 1 to 180 minutes, such as 10 to 120 minutes, or 30 to 60 minutes, to form a surface-treated cutting blade 10. When using an aqueous solution of a metal salt to form the first layer 14, after application of all layers to the surface of the metal cutting blade body 12 to form a coated substrate, the coated substrate may be subjected to a temperature of 120 to 160° C., typically 150° C., for 60 to 180 minutes, usually 90 to 150 minutes.

In certain examples of the present invention as shown in FIG. 2, surface-treated cutting blades 20 comprise (a) a metal cutting blade body 12, that may be any of those disclosed above. The surface-treated cutting blades 20 further comprise (b) a first layer 24 applied to at least one surface of the metal cutting blade body 12. In this example, the first layer 24 comprises chrome, tantalum, or titanium. The chrome, tantalum, or titanium layer 24 typically has a thickness of 2 nm to 200 nm, such as 10 nm to 100 nm, or 20 nm to 80 nm. A thickness of 45 to 55 nm is often used. It is believed that the use of this layer in this thickness range provides durability and extended blade edge retention of blade 20, allowing the blade 20 to remain sharp longer, compared to a similar blade that does not have the chrome, tantalum, or titanium layer applied. The layer 24 may be applied to one surface of the cutting blade body, the tapering tip of the cutting blade body 12, or up to the entire surface of the cutting blade body 12. Application of the layer 24 is typically by a vapor deposition technique, such as physical vapor deposition (PVD).

The surface treated cutting blades 20 as shown in FIG. 2 further comprise (c) a self-assembled monolayer 26 applied to at least a portion of the first layer 24. If the first layer 24 is only on the tip of the cutting blade body 12, the self-assembled monolayer 26 may be applied only on top of the first layer 24 or on both the first layer 24 and directly on the exposed surface of the cutting blade body 12. The self-assembled monolayer 26 is usually formed from monophosphonic acid. Suitable examples of phosphonic acids include organophosphonic acids such as amino trismethylene phosphonic acid, aminobenzylphosphonic acid, 3-amino propyl phosphonic acid, O-aminophenyl phosphonic acid, 4-methoxyphenyl phosphonic acid, aminophenylphosphonic acid, aminophosphonobutyric acid, aminopropylphosphonic acid, benzhydrylphosphonic acid, benzylphosphonic acid, butylphosphonic acid, carboxyethylphosphonic acid, diphenylphosphonic acid, dodecylphosphonic acid, heptadecylphosphonic acid, methylbenzylphosphonic acid, naphthylmethylphosphonic acid, octadecylphosphonic acid, octylphosphonic acid, pentylphosphonic acid, phenylphosphinic acid, phenylphosphonic acid, bis-(perfluoroheptyl)phosphonic acid, perfluorohexyl phosphonic acid, and/or styrene phosphonic acid. Alternatively, the self-assembled monolayer 26 may be formed from any of the alkoxysilanes disclosed above.

A layer 28 formed from an aqueous solution of a metal salt (such as an alkali or alkaline earth metal salt), may preferably be applied to the layer 24 as an intervening layer, prior to application of the self-assembled monolayer 26. Any of the compositions described above as suitable to form the first layer 14 may be used for this intervening layer 28. This intervening layer is believed to enhance durability and provide extended blade edge retention for blade 20. The self-assembled monolayer 26 is applied to at least a portion of the intervening layer 28, such that the intervening layer 28 is situated between the first (chrome, tantalum, or titanium) 24 and second (self-assembled monolayer) layers 26.

Application of the intervening layer 28 and the self-assembled monolayer 26 may be by dipping or spraying.

In certain examples of the present invention as shown in FIG. 3, surface-treated cutting blades 30 comprise (a) a metal cutting blade body 12, that may be any of those disclosed above. The surface-treated cutting blades 30 further comprise (b) a self-assembled monolayer 34 applied directly to at least a portion of the metal cutting blade body 12. In this example, the self-assembled monolayer 34 may be formed from a composition comprising a non-fluorinated organophosphonic acid and/or an alkoxysilane. The organophosphonic acid may comprise any of the non-fluorinated organophosphonic acids described above, and the and alkoxysilane may comprise any of those described above; in particular examples, the alkoxysilane comprises functional groups selected from hydrocarbons containing at least one —CH2- group, polyethylene oxide containing at least three —CH2CH2O— groups, polydialkylsiloxane, phosphonic acid, and combinations thereof, as described above. When the self-assembled monolayer (b) is formed from the organophosphonic acid, the organophosphonic acid may comprise functional groups selected from hydrocarbons containing at least eight —CH2- groups, polyethylene oxide containing at least three —CH2CH2O— groups, polydialkylsiloxane, and combinations thereof.

In certain examples, the composition used to form the self-assembled monolayer 34 comprises octadecylphosphonic acid and/or a polydimethylsiloxane (PDMS) polymer modified with a monophosphonic acid, such that the PDMS polymer contains one or more phosphonic acid functional groups. In this scenario, the phosphonic acid groups may be terminal to the siloxane backbone/chain, and/or in a terminal position of a divalent group such as alkylene that is pendant to a silicon atom in the siloxane chain.

In certain examples, the composition used to form the self-assembled monolayer 34 contains only non-fluorinated compounds. In such a scenario, the monophosphonic acid and alkoxysilane are non-fluorinated. The composition may be essentially free of fluorinated compounds. By “essentially free” of a material is meant that a composition has only trace or incidental amounts of a given material, and that the material is not present in an amount sufficient to affect any properties of the composition. These materials are not essential to the composition and hence the composition is free of these materials in any appreciable or essential amount. If they are present, it is in incidental amounts only, typically less than 0.1 percent by weight, based on the total weight of the composition.

Surface modification chemistry such as that described herein may be used to reduce the cutting force required for sharp edges of cutting blades. It has been found that non-fluorinated surface treatments can achieve the same levels of force reduction as poly(tetrafluoroethylene) coatings, which are most commonly used for this effect on cutting edges. In particular, phosphonic acid compounds that are non-fluorinated can be used in compositions that are essentially free of any fluorinated compounds, to chemically react with the metal surfaces of cutting edges and form a stable monolayer of friction-reducing functional groups on the surface.

Again, a chrome layer similar to that described above may be applied to at least one surface of the metal cutting blade body 12 prior to application of the self-assembled monolayer 34.

The compositions used to form each of the layers are typically essentially free of PFOA.

In each example of the present invention, each layer of the surface treatment can be applied to the metal cutting blade body 12 by conventional means such as dipping, rolling, spraying, wiping to form a film, jet printing, gravure printing, dispensing such as with a syringe, or pad stamping using an applicator pad saturated with the respective composition. Immersion and spraying used most often, although PVD is most effective for the chrome layer. Prior to contacting the metal cutting blade with a surface treatment composition, the metal cutting blade may be cleaned such as by argon plasma treatment or with a caustic solution (e. g., KOH), or a solvent such as IONOX 13416 or CYBERSOLV 141-R, both available from Kyzen.

After application of any appropriate first layers (e. g., the aqueous solution of metal salt or the chrome, tantalum, or titanium layer, if used), the metal cutting blade body 12 is contacted with the composition that forms the self-assembled monolayer. Again, the composition that forms the self-assembled monolayer may be applied to the surface of the substrate by any of the methods noted above, most often by immersion or spraying.

As noted above, the present disclosure also provides methods of reducing deposition of a contaminant on a surface of metal cutting blade such as any of those disclosed above. An exemplary method comprises:
(a) contacting the surface either directly or through an intermediate organometallic layer with a fluorinated material in a diluent, wherein the fluorinated material has the following structure:

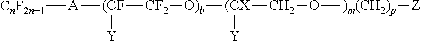

wherein A is an oxygen radical or a chemical bond; n is 1 to 20; Y is H, F, CnH2n+1 or CnF2n+1; X is H or F; b is at least 1, m is 0 to 50, p is 1 to 20, and Z is an acid group or an acid derivative;
(b) forming a hydrophobic surface layer on the surface; and
(c) exposing the cutting blade to the contaminant.

The surface of the cutting blade is surface-treated with a hydrophobic surface layer applied to the surface, by contacting the surface either directly or through an intermediate organometallic layer with a treatment composition comprising a fluorinated material in a diluent. The hydrophobic surface layer comprises a self-assembled monolayer prepared from the fluorinated material. The fluorinated material has the following structure:

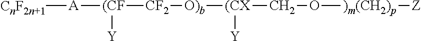

wherein A is an oxygen radical or a chemical bond; n is 1 to 20; Y is H, F, CnH2n+1 or CnF2n+1; X is H or F; b is at least 1, m is 0 to 50, p is 1 to 20, and Z is an acid group or an acid derivative.

In particular examples of the present invention, n is 1 to 6; b is 5 to 12, m is 1 to 6, and p is 2 to 4. Often, Z is selected from:

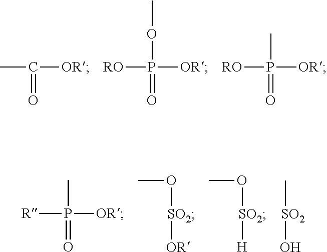

where R″ is a hydrocarbon or substituted hydrocarbon radical having up to 200 carbons, and R and R′ are each independently H, a metal or an amine or an aliphatic or substituted aliphatic radical having 1 to 50 carbons or an aryl or substituted aryl radical having 6 to 50 carbons. Typically, Z is

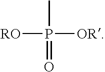

The treatment composition may further comprise a diluent to form a solution. Suitable diluents include alcohols such as methanol, ethanol or propanol; aliphatic hydrocarbons such as hexane, isooctane and decane, ethers, for example, tetrahydrofuran and dialkylethers such as diethylether. Diluents for fluorinated materials can include perfluorinated compounds such as perfluorinated tetrahydrofuran. Also, aqueous alkaline solutions such as sodium and potassium hydroxide can be used as the diluent. In certain examples of the present invention, the diluent may comprise a slow-drying solvent such as glycols, glycol ethers, and hydrofluoroether solvents. Examples of particular hydrofluoroether solvents include 1,1,1,2,2,3,3,4,4-nonafluoro-4-methoxybutane and/or 1,1,1,2,2,3,3,4,4-nonafluoro-4-ethoxybutane, commercially available from 3M Corporation as NOVEC 7200. Other exemplary solvents include 3-ethoxyperfluoro (2-methylhexane) (HFE 7500, also available from 3M Corporation); 1H,1H,5H-Octafluoropentyl-1,1,2,2-tetrafluoroethyl ether (HFE 6512, available from Fuxin Hengtong); and/or 1,1,1,2,3,4,4,5,5,5-Decafluoropentane (VERTREL XF, available from E. I. DuPont de Nemours). Slower drying solvents provide application latitude and control, and are particularly useful when the treatment composition is to be used in regions with warmer weather, and where climate control is not available.

Adjuvant materials may be present in the treatment composition. Examples include surface active agents, stabilizers, and anti-static agents. The adjuvants if present are present in amounts of up to 30 percent by weight, based on the non-volatile content of the treatment composition.

The concentration of the fluorinated material in the solution is not particularly critical but is at least 0.01 millimolar, typically 0.01 to 100 millimolar, and more typically 0.1 to 50 millimolar. The solution can be prepared by mixing all of the components at the same time or by adding the components in several steps.

The cutting blade surface may be prepared and the treatment composition applied thereto as described above.

Adherence of the hydrophobic surface layer to the metal surface may be through physical attraction or through chemically bonding. With physical attraction it is believed the group Z is in the form of the acid, rather than a salt or ester. In the case of chemical bonding, it is believed the acid forms an ionic or covalent bond with reactive groups on the metal surface.

The resultant self-assembled monolayer typically is of nano dimensions, having a thickness of no greater than 100 nm, typically about 10-100 nanometers. The layer is hydrophobic, having a water contact angle greater than 70°, typically from 75-130°. The water contact angle can be determined using a contact angle goniometer such as a TANTEC contact angle meter Model CAM-MICRO™.

The hydrophobic surface layer may be adhered to the metal surface either directly or indirectly through an intermediate organometallic coating, such as any of those described above. When better adhesion and durability than that afforded by direct application is desired, an organometallic coating should be applied to the metal surface followed by application of the treatment composition.

Although not intending to be bound by any theory, it is believed the acid groups of the Z moiety chemically bond with oxide or hydroxyl groups on the metal surface or chemically bond with the hydroxyl or alkoxide group of the organometallic coating, resulting in a durable film. It is believed that the fluorinated material forms a self-assembled monolayer on the surface of the substrate (i.e., the metal surface or organometallic coating layer). Self-assembled layers or films are formed by the chemisorption and spontaneous organization of the material on the surface of the substrate. The fluorinated materials useful in the practice of the invention are amphiphilic molecules that have two functional groups. The first functional group, i.e., the head functional group, is the acid group and attaches by physical attraction or by chemical bonding to the surface of the substrate. The second functional group, the fluoro-functional group, i.e., the tail, extends outwardly from the surface of the substrate.

Typically, the hydrophobic surface layer is adhered to the metal surface, rendering the surfaces of the cutting blade resistant to deposition of a contaminant thereon.

After formation of the hydrophobic surface layer on the metal surface, the method comprises c) exposing the cutting blade to the contaminant. The nature of the contaminant depends on the use of the cutting blade. It may include foodstuffs, proteinaceous compounds, blood or blood components, hair, grease, oil, etc. The hydrophobic surface layer on the metal surface reduces deposition of the contaminant on the metal surface, allowing for easier cleaning of the cutting blade.

Whereas particular embodiments of this invention have been described above for purposes of illustration, it will be evident to those skilled in the art that numerous variations of the details of the present invention may be made without departing from the scope of the invention as defined in the appended claims.

What is claimed is:

1. A surface-treated cutting blade comprising:
(a) a metal cutting blade body;
(b) a first layer applied to at least one surface of the metal cutting blade body, wherein the first layer comprises chrome, tantalum, or titanium having a thickness of 2 nm to 200 nm;
(c) an intervening layer applied to at least a portion of the first layer, wherein the intervening layer is formed from an aqueous solution of an alkali or alkaline earth metal salt; and
(d) a self-assembled monolayer applied to at least a portion of the intervening layer, wherein the self-assembled monolayer is formed from a monophosphonic acid.

2. The surface-treated cutting blade of claim 1, wherein the cutting blade is a razor blade and the metal cutting blade body (a) comprises steel.

3. The surface-treated cutting blade of claim 1, wherein the alkali or alkaline earth metal salt comprises sodium silicate.

4. A surface-treated cutting blade comprising:
(a) a metal cutting blade body;
(b) a first layer applied to at least one surface of the metal cutting blade body, wherein the first layer is formed from:
(i) an aqueous solution of a metal salt; or
(ii) an organometallic compound; and
(c) a self-assembled monolayer applied to at least a portion of the first layer, wherein the self-assembled monolayer is formed from an alkoxysilane.

5. The surface-treated cutting blade of claim 4, wherein the metal cutting blade body (a) comprises steel and/or titanium.

6. The surface-treated cutting blade of claim 5, wherein the cutting blade is a razor blade.

7. The surface-treated cutting blade of claim 4, wherein the first layer is formed from the aqueous solution (i) and the metal salt comprises an alkali or alkaline earth metal salt.

8. The surface-treated cutting blade of claim 7, wherein the metal salt comprises sodium silicate.

9. The surface-treated cutting blade of claim 4, wherein the first layer is formed from the organometallic compound (ii), which comprises a polymeric metal oxide having unreacted alkoxide and/or hydroxyl groups.

10. The surface-treated cutting blade of claim 4, wherein the alkoxysilane comprises a monosilanol, a disilanol, a trisilanol, or mixtures thereof.

11. The surface-treated cutting blade of claim 4, wherein the alkoxysilane comprises functional groups selected from perfluoroalkyl, perfluoroalkyl ether, hydrocarbons containing at least one —CH₂— group, polyethylene oxide containing at least three —CH₂CH₂O— groups, polydialkylsiloxane, and combinations thereof.

12. A surface-treated cutting blade comprising:
(a) a metal cutting blade body; and
(b) a self-assembled monolayer applied directly to at least a portion of the metal cutting blade body (a), wherein the self-assembled monolayer (b) is formed from a composition comprising a non-fluorinated organophosphonic acid and/or an alkoxysilane.

13. The surface-treated cutting blade of claim 12, wherein when the self-assembled monolayer (b) is formed from the alkoxysilane, the alkoxysilane comprises functional groups selected from hydrocarbons containing at least one —CH₂— group, polyethylene oxide containing at least three —CH₂CH₂O— groups, polydialkylsiloxane, phosphonic acid, and combinations thereof; and
when the self-assembled monolayer (b) is formed from the organophosphonic acid, the organophosphonic acid comprises functional groups selected from hydrocarbons containing at least eight —CH₂— groups, polyethylene oxide containing at least three —CH₂CH₂O— groups, polydialkylsiloxane, and combinations thereof.

14. The surface-treated cutting blade of claim 12, wherein the cutting blade is a razor blade and the metal cutting blade body (a) comprises steel and/or titanium.

15. The surface-treated cutting blade of claim 12, wherein the composition used to form the self-assembled monolayer (b) comprises the alkoxysilane, which in turn comprises a monosilanol, a disilanol, a trisilanol, or mixtures thereof.

16. The surface-treated cutting blade of claim 12, wherein the composition used to form the self-assembled monolayer (b) comprises octadecylphosphonic acid and/or a polydimethylsiloxane polymer containing one or more phosphonic acid functional groups.

17. The surface-treated cutting blade of claim 12, further comprising an intervening layer between the metal cutting blade body and the self-assembled monolayer, wherein the intervening layer comprises chrome, tantalum or titanium having a thickness of 2 nm to 200 nm.

18. The surface-treated cutting blade of claim 12, wherein the composition used to form the self-assembled monolayer (b) comprises octadecylphosphonic acid and a polydimethylsiloxane polymer containing one or more phosphonic acid functional groups.

19. The surface-treated cutting blade of claim 12, wherein the cutting blade is a steel razor blade.

20. The surface-treated cutting blade of claim 19, wherein the composition used to form the self-assembled monolayer (b) comprises the alkoxysilane, which in turn comprises a monosilanol, a disilanol, a trisilanol, or mixtures thereof.
